(19) United States
(12) Patent Application Publication
(10) Pub. No.: US 2005/0074216 A1
(43) Pub. Date: Apr. 7, 2005

(54) Side-illumination type optical fiber

(76) Inventor: Shinichi Irie, Hachioji-shi (JP)

Correspondence Address: 3M INNOVATIVE PROPERTIES COMPANY, PO BOX 33427, ST. PAUL, MN, 55133-3427, US

(21) Appl. No.: 10/433,303

(22) PCT Filed: Nov. 21, 2001
(86) PCT No.: PCT/US01/43405

(30) Foreign Application Priority Data
Dec. 21, 2000 (JP) 2000-389331

(51) Int. Cl. G02B 6/22

(52) U.S. Cl. 385/127; 385/128

(57) ABSTRACT

A side light type optical fiber, includes a core and a cladding disposed around the core, the cladding including a transparent first layer contacting the core, and a light diffusive second layer formed around the first layer, the layers being integrally molded.

### TECHNICAL FIELD

The present invention relates to a side light type optical fiber. Particularly, it relates to a side light type optical fiber, which emits light introduced from at least one end of a core in a longitudinal direction through a cladding surrounding the core.

### BACKGROUND ART

As is already known to the art, a discharge tube, like a fluorescent tube, emits visible light having a specified wave length region, and is used for illumination purposes. When the discharge tube is a neon tube, the tube is often employed for advertisement or ornamental use in the form of neon signs. The discharge tube emits light when applying an electric discharge. It also emits heat together with light. The heat and leakage of electricity should be considered when using the discharge tube. The discharge tube, as the result, can not be used for illuminating or displaying in water.

In order to realize the illumination or display in water, an illuminating device in which its light source is placed separate from a place to be illuminated or displayed has been recently suggested. The illuminating device comprises a light source which is separately placed from an illuminating or displaying place, and an optical fiber for illumination or display, placed near or at the illuminating or displaying place. The optical fiber generally includes a core at a center portion, in which a light introduced from one end of the fiber is transmitted to the other end, and a cladding having lower refractive index than the core, disposed around the core.

Among the optical fibers, there has been known a side light type optical fiber which can emit light from its side portion. The side light type optical fiber is explained by reference with FIG. 4. The optical fiber 20 is flexible and includes a core 21 formed from acrylic resin or the like, and a cladding 22 formed from Polytetrafluoroethylene available commercially under the name Teflon™ from E.I. Dupont de Nemours and Company and the like, as disclosed in U.S. Pat. No. 4,422,719. The cladding 22 uniformly contains light diffusive particles, such as metal oxide particles (e.g. titanium dioxide particles) in an amount of 2 to 10% by weight. In addition, Japanese Kokai Publication Hei-10 (1998)-148725 discloses an optical fiber which is obtained by co-extruding a melted fluoropolymer containing 50 to 4,000 ppm of at least one light diffusive additive with a crosslinkable resin mixture for core. WO 98/08024 also discloses an optical fiber which is formed by melt-casting a semi-transparent cladding material containing white or another color pigment on a surface of a core. The optical fibers mentioned above can emit a light through the cladding, when light is introduced from one or both ends of the fiber to transmit within the fiber.

It is also known that the cladding layer contains another layer light diffusive layer. For example, Japanese Kokai 2000-131530 discloses that a cladding layer is divided into two layers, one of which contains light diffusive particles to constitute a light diffusive layer and the other is a transparent layer not containing light diffusive particles, formed on the light diffusive layer. The two layers are integrally formed by co-extrusion. In this technique, the light diffusive layer is directly contacted with the core.

In the construction obtained in Japanese Kokai 2000-131530, a lateral luminance of the fiber is effectively enhanced in especially a portion near the light source, but the luminance would attenuate as parting from the light source. This is because the greater the distance from the light source, the more the luminance attenuates. Accordingly, the optical fiber disclosed in Japanese Kokai 2000-131530 is not effectively used for an illumination device having a long fiber length of 10 m or more, when the fiber is used as a light illuminant.

### SUMMARY OF INVENTION

The present invention, as attaining the above-mentioned object, provides a side light type optical fiber (referred sometimes to as merely “optical fiber”), which comprises a core and a cladding disposed around the core, the cladding is including a transparent first layer contacting the core, and a light diffusive second layer formed around the first layer, the both layers being integrally molded. In the present invention, the first layer preferably has a thickness of 50 to 300 μm. The core preferably has a diameter of 5 to 30 mm. It is also preferred that the cladding has a dual layer structure formed by a co-extrusion method of two materials for the first and second layers.

### BRIEF DESCRIPTION OF THE DRAWINGS

FIG. 1 A schematic cross sectional view of the side light type optical fiber of the present invention.

FIG. 2 A graph showing a result of test of side light luminance of Examples and Comparative Examples. This figure shows a change of luminance against distance from a light source.

FIG. 3 A graph showing a result of test of side light luminance of Examples and Comparative Examples. This figure shows a change of luminance against a measuring angle at 2 mm away from a light source.

FIG. 4 A schematic cross sectional view of the side light type optical fiber of a prior art.

### DETAILED DESCRIPTION

The long side light type optical fiber with 10 m or more length, can also be obtained by covering an optical fiber having a transparent single-layer cladding on the core with a light diffusive semi-transparent resin layer so as to enhance uniformity of luminance over a longitudinal direction and to emit light brightly. This is because an optical fiber including a core and a transparent single-layer cladding covering on the core can transmit light from one end to the other end in a longitudinal direction without leaking light from a surface of the cladding, that is, side face. This is because light introduced in the fiber is effectively transmitted by total internal reflection at an interface between the cladding having a relatively lower refractive index and the core having a relatively higher refractive index.

On the other hand, in case where the core has a relatively larger diameter, for example more than 3 mm, the light in the fiber leaks slightly out from the side face to illuminate a little over the longitudinal dimension, even if the cladding does not contain light diffusive particles. The larger the diameter of the core, the more the phenomenon occurs, because more light which does not meet conditions for total internal reflection and reaches the interface between core and cladding is present. In addition, an adhesion between the cladding and the core microscopically is not uniform in some portions, although it visibly has very good transparency. The portions having nonuniformities become illuminating points.

The leaking light has generally a relatively low angle to a direction parallel to the cladding side face and largely contains components to emit out from the cladding side face. Accordingly, the optical fiber having a semi-transparent light-diffusive resin layer on the cladding has sufficient uniformity of luminance over the longitudinal direction, but is poor in luminance strength because of the leakage of light, so that the fiber is not used for a long light illuminant, like a neon tube.

This necessitates that the light-diffusive layer be more closely adhered to the cladding surface to reduce the escapes of light having a relatively low angle to a direction parallel to the cladding side face and to increase the escape of light having a relative high angle to the direction parallel to the cladding side face.

In order to closely adhere a light-diffusive layer on the cladding surface, some methods are already known. For example, there is a method for covering an electric wire with resin, which comprises cool-solidifying a resin melted mixture of a transparent polymer and white inorganic powder dispersed therein onto the surface of the cladding layer of the optical fiber. Another method comprises preparing a light-diffusive resin tube and inserting an optical fiber into the light-diffusive resin tube.

However, the above-mentioned methods both include an additional step for covering the light-diffusive layer on the cladding surface to result in increase of cost for production.

In addition, since the light-diffusive layer is separately formed and covered on the surface of the cladding, it is difficult to enhance an adhesion between the cladding and the light-diffusive layer. This often creates layer separation between the light-diffusive layer and the cladding because of a bending operation of the fiber, a change of temperature and the like. Once the layer separation occurs, the luminance of the separated portion reduces and generates some difference on luminance over the fiber. The fiber thus does not operate well as a light illuminant for illumination.

The present inventors have studied more about occurrence of layer separation between the fiber and the light-diffusive layer and have found that the occurrence of layer separation is observed more often when the optical fiber has a larger core diameter, especially 5 mm or more core diameter. The reasons why the tendency exists will be described below.

In case of glass fiber, the fiber is twisted to absorb bending deformation, to result in the glass fiber bending without breakage. On the other hand, if a glass article has a larger diameter than the fiber, for example a glass rod, it can not bend at all and therefore if too much bending force is applied on the rod it will break. It is generally true that a rod shape article having a large diameter does not twist at all against bending operation and does not absorb the bending deformation. Accordingly, the layer separation between the cladding and the light-diffusive layer operates as the same as the glass rod and occurs often when the optical fiber has a lager diameter.

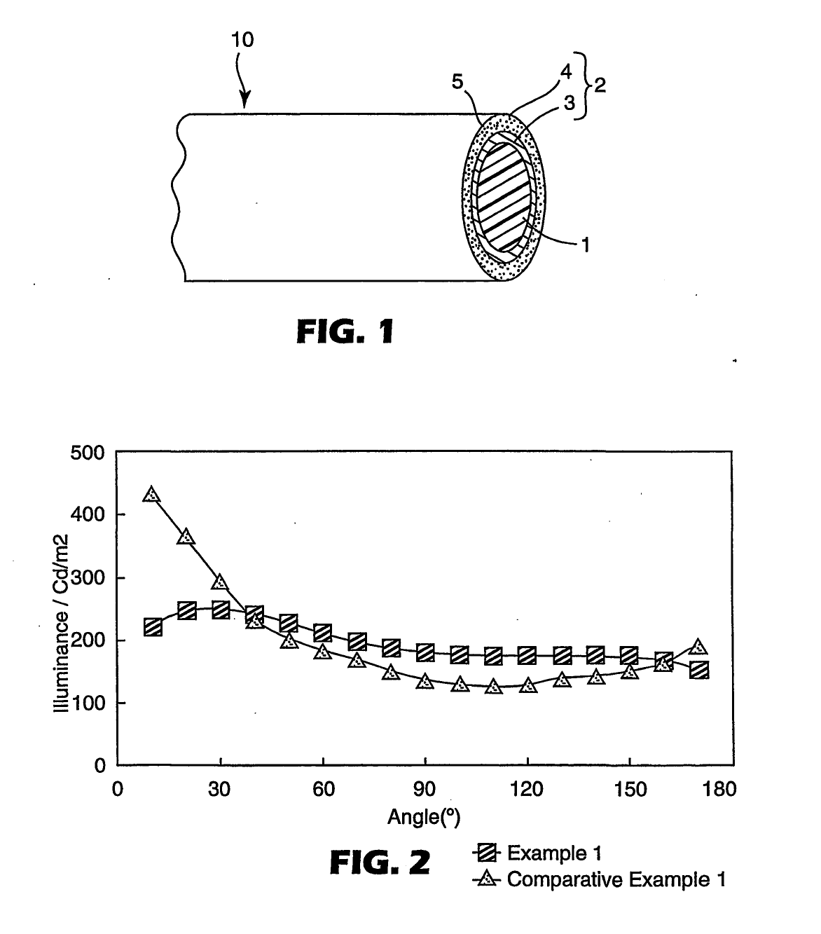

The present invention will be explained referring with representative embodiments. In the drawings attached to the present application, the same numbers show same elements or equivalent elements. In FIG. 1, an optical fiber 10 is indicated as one embodiment of the present invention. The optical fiber 10 has a core 1 at its center portion and a cladding 2 surrounding the core 1.

The core is generally formed from polymer. The core formed from polymer can be obtained by polymerizing a polymerizable material. The core can accept light without loss from a light source from one or both exposed ends into the core. The core has a sufficient light transmittance and transmits light from one end to the other end.

The core has a light transmittance of not less than 80%. By the term “light transmittance” herein is meant a value determined by a spectrophotometer using a light having a wavelength of 550 nm. The polymer for the core generally has a refractive index of 1.4 to 1.7.

The core preferably is a solid core formed from flexible polymer. The flexible polymer can preferably be acrylic polymer, ethylene-vinyl acetate copolymer, vinyl acetate-vinyl chloride copolymer or a mixture thereof. The polymer of the core can preferably be crosslinked in order to enhance water resistance.

The polymerizable material for the core can be an acrylic monomer mixture. The acrylic monomer mixture for the core contains (1) a polymerizable acrylic monomer not having a hydroxyl group in a molecule and (2) a polymerizable hydroxyl-containing acrylic monomer. The term “acrylic monomer” used herein include either a monomer having an acrylic group or a monomer having a methacrylic group or both. Preferred is a methacrylate, i.e. methacrylic ester. The methacrylate can easily control a core Tg to a suitable range and can effectively enhance properties in water resistance, light transmittance and the like. The polymerizable material for the core can also be a (meth)acrylic oligomer formed by reacting at least two monomers, as long as the technical effects of the present invention does not deteriorate. A crosslinkable monomer having two or more functional groups can also be used in addition to the mono-functional monomer.

Examples of the acrylic monomers not having an hydroxyl group are a methacrylate, such as methyl methacrylate, ethyl methacrylate, n-butyl methacrylate, 2-ethylhexyl methacrylate, isobutyl methacrylate, t-butyl methacrylate, lauryl methacrylate, dodecyl methacrylate and stearyl methacrylate. An acrylate not having hydroxyl group can be used in addition to the methacrylate and include methyl acrylate, ethyl acrylate, n-butyl acrylate, 2-ethylhexyl acrylate, isoamyl acrylate, lauryl acrylate, stearyl acrylate, isooctyl acrylate or the like. An unsaturated acid, such as acrylic acid or methacrylic acid can also be used as the monomer.

Examples of the hydroxyl-containing acrylic monomers are 2-hydroxyethyl methacrylate, 2-hydroxyethyl acrylate, 2-hydroxypropyl methacrylate, 2-hydroxypropyl acrylate, 3-hydroxypropyl methacrylate, 3-hydroxypropyl acrylate, diethyleneglycol monomethacrylate, diethyleneglycol monoacrylate, triethyleneglycol monomethacrylate, triethyleneglycol monoacrylate and the like.

Examples of the crosslinking agents to crosslink the core polymer are polyfunctional monomers, such as dially phtharate, triethyleneglycol di(meth)acrylate, diethyleneglycol bisallylcarbonate and the like.

Preferred examples of the acrylic monomer mixtures for the present invention include:

(a) a mixture of 2-hydroxyethyl methacrylate, methyl methacrylate, n-butyl methacrylate and triethyleneglycol di(meth)acrylate;

(b) a mixture of 2-hydroxyethyl methacrylate, n-butyl methacrylate and triethyleneglycol di(meth)acrylate; and

(c) a mixture of 2-hydroxyethyl methacrylate, n-butyl methacrylate, 2-ethylehexyl methacrylate and triethyleneglycol di(meth)acrylate; and the like.

In case where the core polymer is crosslinked by using a crosslinking agent, an amount of the crosslinking agent can preferably be 0.01 to 5.0% by weight, more preferably 0.1 to 4.5% by weight based on a total weight of the polymerizable material. The core may also contain an additive as long as the core does not deteriorate its properties. Examples of the additives are plasticizer, surfactant, colorant, stabilizer for heat, oxidation or ultraviolet light, and the like.

Any ingredient of the polymerizable material for the core can be varied so as to satisfy properties, such as softness, weather resistance, coloring resistance and water resistance. A length of the core may generally be 50 to 100 m, but is not limited thereto. For exhibiting the technical effects of the present invention, it is preferred that the core has a length of 10 m or more, more preferably 15 m or more. The core generally has a cross section of about circle or ellipse in a direction of diameter, but does not limit thereto.

The core generally has a diameter of 3 to 30 mm. Diameters of less than the lower diameter generally do not fit an application to illumination, because an area of illuminating is too thin and small for observers to see the illumination. On the other hand, diameters of more than larger limitation would significantly have attenuation of luminance in a longitudinal direction and not enhance uniformity of luminance. In addition, the larger diameters reduce flexibility of the optical fiber and therefore do not form into an illumination apparatus containing the fiber having a desired shape. It is therefore preferred for showing good performance as an illuminant that the core has a diameter of 6 to 27 mm, more suitably of 7 to 20 mm.

The cladding 2, as explained above, integrally molds both the first layer 3 and the second layer 4 together. Preferably, the cladding 2 can be formed by a co-extrusion method, in which two or more layers for forming the cladding are melt-extruded together to form layer and cooled to solidify. The method effectively enhances an adhesion between the layers and does not increase number of steps for forming the cladding. The cladding of the present invention therefore can be produced as the same as a conventional cladding having a single layer with the exception that the cladding has plural layers.

Materials for forming each cladding layer are not limited, but generally include a polymer, such as tetrafluoroetylene-hexafluoropropylene copolymer (FEP), tetrafluoroethylene-hexafluoropropylene-vinylidene fluoride copolymer, trifluroethyle-vinylidene fluoride copolymer, polymethylpentene, ethylene-vinyl acetate copolymer, vinyl acetate-vinyl chloride copolymer or the like. It is noted that the first layer contacting the core of the cladding has lower refractive index than the core.

The cladding may contain some additive as long as the addition does not deteriorate the performance of the present invention. Examples of the additives are plasticizer, sufactant, curing agent, filler (e.g. white pigment), colorant (e.g. dyestuff), stabilizer and the like.

The second layer being light diffusive property can generally be formed from a material containing fluorine-containing polymer and light diffusive particles dispersed in the fluorine-containing polymer. An amount of the light diffusive particles is generally within the range of 0.01 to 50% by weight, preferably 0.1 to 45% by weight, more preferably 1 to 40% by weight based on a total weight of the second layer. Amounts of less than the lower limitation may not have sufficient luminance (e.g. 100 candera/m² or more for white illuminant) for an illuminant like neon signs. Amounts of more than 50% by weight may not emit light having enough luminance throughout a longitudinal direction.

The light diffusive particles can generally be glass beads or beads obtained from another material, and inorganic particles, such as titanium dioxide or silicon dioxide. Concrete examples of the particles are white inorganic particles having a refractive index of 1.5 to 3.0. Preferred examples of the white inorganic particles are barium sulfate (refractive index=1.5), magnesia (refractive index=1.8) and titania (titanium dioxide; refractive index=2.6.

The light diffusive particles can be other ones as long as they do not deteriorate the technical effects of the present invention. In addition to the light diffusive particles, a colorant, such as fluorescent dye, can also be contained in the cladding layer to change white light introduced into the core to colored light and to emit it.

A transparency of the cladding first layer can be shown as light transmittance and is preferably more than 60%, more preferably more than 70%, most preferably more than 90%. If the cladding first layer has too small light transmittance, the illuminant of the fiber would reduce.

The cladding first layer preferably has a thickness of 50 to 300 μm, more preferably 70 to 280 μm, most preferably 100 to 250 μm. It the cladding first layer has too small thickness, the attenuation of luminance would be significant over in a longitudinal direction and does not enhance uniformity of luminance in the longitudinal direction. In case where the core has a diameter of 5 mm or more, it is preferred that the cladding first layer should be as thick as possible for enhancing the uniformity of luminance. If the cladding first layer is too thick, a luminance at portions away from the light-introduced point would reduce and the uniformity of luminance does not keep so far. In either case, the optical fiber is not suitable for an illuminant for illumination.

A thickness of the second layer of the cladding is not specifically limited and can be selected such a range as not to make the cladding opaque. It is preferred that the second layer has a thickness of more than 10 μm and the cladding totally has a thickness of not more than 2 mm.

The optical fiber of the present invention is produced by preparing a tube type cladding having a desired length and filling a polymerizable material into the tube type cladding, followed by polymerizing the material to form a polymerized core and a cladding covering the core. Detailed explanation of production is explained hereinafter.

First of all, a cladding (i.e. cladding tube) is prepared. The cladding is generally obtained by a co-extrusion method to form a cladding tube having desired thickness, diameter and length. The cladding produced above is wound on a feed roll. The cladding wound on the feed roll is wound up on a wind-up roll. A combination of the feed roll and the wind-up roll is employed and a continuous cladding in a longitudinal direction is sent from the feed roll to the wind-up roll, between which a heating zone (a container containing a medium for heating, e.g. heated water container) is present and the cladding is driven through the heating zone.

The heating zone, that is, heating container may have two openings through which the cladding is driven. The two openings are a cladding inlet opening in the side of the feed roll and a cladding outlet opening in the side of the wind-up roll. The heating container can be one having one opening facing up side of a perpendicular direction. The cladding is introduced inside the container through the one opening, its direction is changed near the bottom of the container and the cladding is then sent out through the same opening. As explained above, the cladding is dipped in a heating medium to finish polymerization of core and then an optical fiber is taken out of the opening.

The polymerizable material for the core is generally filled in the cladding tube at a suitable pressure. In this method, the material is put into the cladding from the other end and then one end of the cladding is sealed. The sealing of the cladding can be conducted by caulking the one end of the cladding with a metal cap or a valve. Filling-up of the polymerizable material into the cladding tube can be conducted by connecting one open end of the cladding with a tank for the polymerizable material and the inside of the tank is pressured to continuously put the material into the cladding tube.

As mentioned above, the polymerizable material in the cladding is heated in the heating zone to start and finish polymerization reaction to obtain the optical fiber having the core closely adhered to the cladding layer.

Heating can be conducted at a temperature of 35 to 90° C., preferably 40 85° C. A time for the cladding to stay in the heating zone is not specifically limited, but generally is 10 minutes to 5 hours, preferably 15 minutes to 3 hours. The cladding preferably has a length of 10 to 3,000 m, preferably 20 to 2,000 m.

The cladding preferably has an elasticity of 10 to 700 MPa, preferably 20 to 600 MPa. The “elasticity” of the cladding is a value at a heating temperature. The cladding preferably has a tube thickness of 0.01 to 2 mm, preferably 0.05 to 1.5 mm, more preferably 0.2 to 1 mm. If it is too thin, the water resistance of the optical fiber would reduce. If it is too thick, flexibility would lower. The inside diameter of the cladding can be determined by the core diameter of the final optical fiber.

The optical fiber of the present invention is suitably used as a long illuminant of an illumination apparatus, equipped with an information sign, such as an advertising board, a neon sign and a road sign.

The optical fiber of the present invention can emit light introduced from one end or both ends of the core to outside through side face or surrounding face of the cladding. A light source can be a high-luminance lamp, such as a xenon lamp, a halogen lamp, a flush lamp. The lamps generally consume 10 to 500 W of electric power.

For example, the optical fiber of the present invention is used as a long illuminant as shown in FIG. 5, thus forming an illumination apparatus. In FIG. 5, a side light portion 30 formed by the long optical fiber of the present invention shows a figure containing some curved lines. In the illumination apparatus of the present invention, the illuminant containing such figures constitutes all or a portion of advertisement or guiding information.

A light transmitting portion 32 connecting a light source 31 with the side light portion 31 does not constitute the above-mentioned information. Accordingly, it is preferred that the light transmitting portion 32 is covered with light screening jacket (black soft vinyl chloride resin) not to emit light.

The optical fiber of the present invention does not generate layer peeling even by bending operation. Accordingly, the optical fiber is very easy to form to a design containing the curved line as shown in FIG. 5, letters and symbols, which therefore shows satisfactory performance as an illuminant for illuminations.

In case where the optical fiber of the present invention is used as a long illuminant for an illumination apparatus, the fiber preferably has a length of 10 to 50 m, preferably 15 to 40 m if light is introduced from one end of the fiber by one light source, and has a length of 10 to 100 m, preferably 15 to 80 m if light is introduced from both end by two light sources.

### EXAMPLES

### Example 1

A cladding having a first layer and a second layer, both being integrally formed, was prepared.

Two extruders were employed and an extruding end of each extruder was connected with a co-extrusion die. Into one of the extruder, tetrafluoroethylene-hexafluropropylene (FEP) resin (FEP 100J available from Mitsui Du Pont Chemical Co., Ltd.) was put for a first layer. Into the other extruder, a mixture of 100 parts by weight of FEP 100J and 1 part by weight of NP 20 WH (FEP available from Daikin Industries Co., Ltd.) was put for a second layer. The NP 20 WH resin contained 2.3% by weight of titanium dioxide. Accordingly, the second layer of this example had about 2.3% by weight of titanium dioxide (light-diffusive particles). The cladding first layer had a light transmittance of 9.5%.

By using the above mentioned extruders, a cladding for the Example was prepared. The cladding had a tube shape and had openings at both ends. The first layer of the cladding had a transparent resin layer having a thickness of about 200 μm and the second layer had a light-diffusive layer having a thickness of about 450 μm. The cladding had an outside diameter of about 15 mm.

As a polymerizable material for a core, a monomer mixture was prepared from 4 parts by weight of hydroxyethyl methacrylate, 80 parts by weight of n-butyl methacrylate, 16 parts by weight of 2-ethylhexyl methacrylate and one part by weight of triethyleneglycol dimethacrylate, into which lauroyl peroxide (polymerization initiator) was added.

The polymerizable material was poured into the cladding from one end and then the other end was sealed. The polymerization material was heated to polymerize in the heating zone by driving the sealed end of the cladding and continuously sending it, as contacting nitrogen gas from the other open end. The polymerized material formed a solid core to obtain a side light type optical fiber.

### Example 2

A side light type optical fiber was prepared as generally described in Example 1, with the exception that an amount of NP 20 WH introduced into the other extruder was changed from 1 part by weight to 20 parts by weight. The cladding second layer of the obtained fiber had about 38.3% by weight of light-diffusive particles (titanium dioxide).

### Comparative Example 1

A side light type optical fiber was prepared as generally described in Example 1, with the exception that NP 20 WH was not used and only PEP 100 J was employed.

### Comparative Example 2

A side light type optical fiber was prepared as generally described in Example 1, with the exception that the resin for the extruder 1 was changed to a mixture of FEP 100 J and NP 20 WH in an amount ratio of 10:1 and the resin for the extruder 2 was only FEP 100 J. In this experiment, the first layer had light-diffusive properties and the second layer is transparent. The cladding second layer had a light transmittance of 95%.

(1) Determination of Side Light Luminance

A side light luminance was determined as following.

A metal halide lamp (LBM 130 H available from Sumitomo 3M Co.; consumed electric power of 130 W) was connected with a core of an optical fiber at one end. The light source was put on and a luminance was determined at a position apart from the light source in a given distance by a luminance meter available from Minolta Co., Ltd. as CS-100. The luminance meter was positioned a point away from the side face of the optical fiber in 60 cm. It is noted that an angle of a normal of an area receiving light of the luminance meter with a longitudinal direction of the core was set 90°.

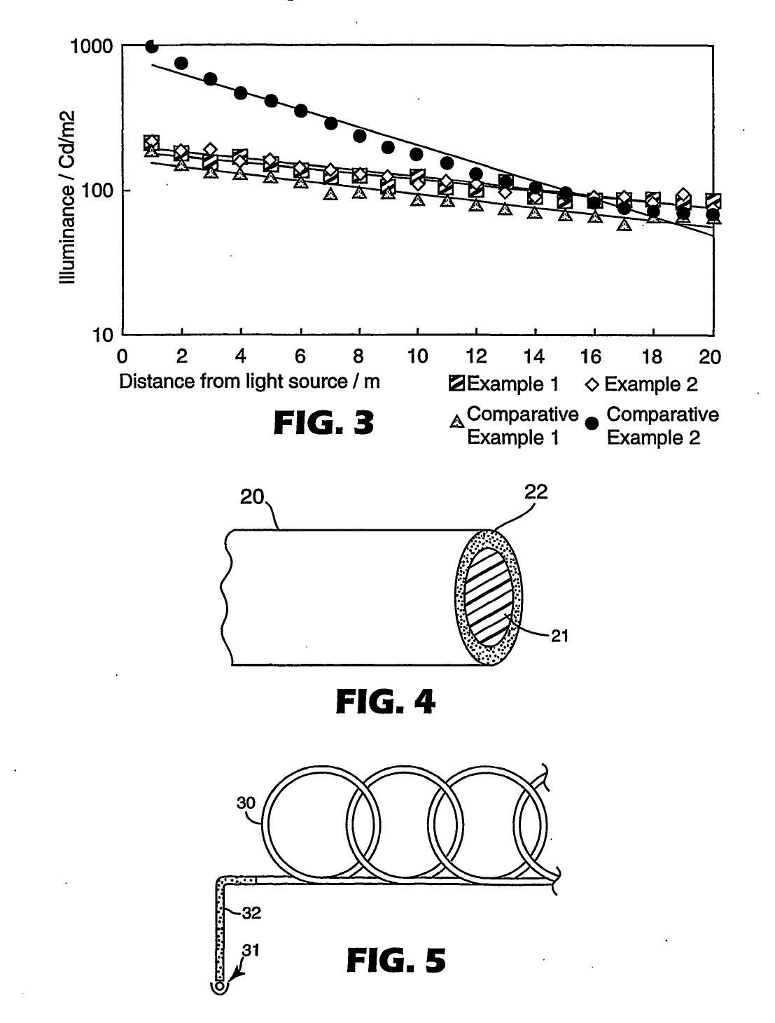

The results of the determination are shown in FIGS. 2 and 3.

FIG. 2 shows a change of luminance against a distance from a light source, that is an evaluation of uniformity of luminance over a longitudinal direction. The optical fibers of Examples 1 and 2 had higher uniformity compared with those of Comparative Example 2. In Comparative Example 2, a luminance at a potion near the light source was very high, but the longer the distance of the measuring point from the light source, the lower the luminance with relatively sharp steep. On the other hand, the optical fibers of Examples 1 and 2 had a very little decline of luminance as parting a determining position from a light source.

In Comparative Example 1, luminance was very low throughout a longitudinal direction of the fiber, in comparison with the fibers of Examples 1 and 2.

As is apparent from the above evaluation, the optical fibers of Examples 1 and 2 are more suitable for a long illuminant for illumination than those of Comparative Examples 1 and 2.

FIG. 3 shows a change of luminance against a measuring angle at a position of 2 mm from a light source. In FIG. 3, an axis of ordinates indicates an angle of a normal of an area receiving light of a luminance meter with a longitudinal direction of the core.

In this case, a direction which is parallel to the side surface of the cladding and faces to one end of connecting the light source is 180° and a direction which is parallel to the side surface of the cladding and faces to the other end is zero degree, i.e. 0°.

The optical fiber of Example 1 enhanced a luminance of a light component near a perpendicular to the side area of the cladding, in comparison with the fiber of Comparative Example 1 which does not have a cladding layer. Accordingly, the presence of the light diffusive layer at an outermost surface can diffuse light having a low angle more to effectively enhance a luminance of a light component near the perpendicular to the side area of the cladding.

Evaluation to Flexure

The optical fiber of Examples was cut into 1 m length and bent 10 times at a bending angle of 90° with a curvature radius of 8 times of a core diameter (r=about 10 mm). After that, an evaluation was conducted about whether layer separation occurred in the cladding or not. The optical fibers of Examples 1 and 2 did not have the separation at all between the first and second layers and also did not show any difference in appearance when connected with a light source between before and after the flexure test.

The side light type optical fiber of the present invention has uniform luminance of side light over a longitudinal direction, even if the fiber is relatively long. In addition, the optical fiber of the present invention can effectively prevent from layer separation between a first transparent layer contacting the core and a second light-diffusive layer, even if it has a relatively larger core diameter.

1. A side light type optical fiber, comprising a core and a cladding disposed around said core,
said cladding is composed of a transparent first layer contacting said core, and a light diffusive second layer formed around the first layer, the both layers being integrally molded.

2. The side light type optical fiber according to claim 1, wherein said first layer has a thickness of 50 to 300 μm.

3. The side light type optical fiber according to claim 1, wherein said core has a diameter of 5 to 30 mm.

4. The side light type optical fiber according to claim 1, wherein said cladding has a dual layer structure formed by a co-extrusion method of two materials for the first and second layers.
